(19) United States
(12) Patent Application Publication
(10) Pub. No.: US 2013/0045044 A1
(43) Pub. Date: Feb. 21, 2013

(54) CASE-FIXING STRUCTURE

(71) Applicant: Tadashi Akiyama, Okazaki-shi (JP)

(72) Inventor: Tadashi Akiyama, Okazaki-shi (JP)

(73) Assignee: TOYOTA JIDOSHA KABUSHIKI KAISHA, Toyota-shi, Aichi-ken (JP)

(21) Appl. No.: 13/643,401

(22) PCT Filed: Apr. 28, 2010
(86) PCT No.: PCT/JP2010/057550

§ 371 Date: Oct. 25, 2012

(51) Int. Cl. F16B 5/00; F16F 15/08; F16B 35/04

(52) U.S. Cl. 403/291

(57) ABSTRACT

A case-fixing structure includes a seat plate, a case located on the seat plate, a connecting member connected to the seat plate, a coupling member fixed to the connecting member and coupling the connecting member and the case, a buffer member disposed between the coupling member and the case, and a protruding part provided for the case. When a load heavier than specified is applied to the case, the protruding part can be brought into contact with at least one of the coupling member, the connecting member and the seat plate. When the protruding part is brought into contact with at least one of the coupling member, the connecting member and the seat plate, connection between the connecting member and the seat plate can be canceled.

### TECHNICAL FIELD

The present invention relates to a case-fixing structure, and more particularly to a case-fixing structure including a case and a seat plate on which the case is mounted.

### BACKGROUND ART

Conventionally, various types of case-fixing structure in which an inverter and the like are stored have been proposed. For example, an enclosure-fixing structure described in Japanese Patent Laying-Open No. 2008-248936 (PTL 1) includes a bracket fixed to one of an enclosure and a vehicular body, and an arm extending from the other one of the enclosure and the vehicular body to the bracket. The bracket has a first fixing metal fitting fixed to the arm, a second fixing metal fitting fixed to the enclosure or the vehicular body to which the bracket is attached, and an elastic body interposed between the first fixing bracket and the second fixing bracket.

The fixing structure for on-board equipment described in Japanese Patent Laying-Open No. 2009-90818 (PTL 2) includes a mount table, an inverter mounted on the mount table, a guide member extending rearward from the mount table and being inclined upward, and a coupling member coupling the guide member and the inverter.

The coupling member is fitted within a recess formed in the guide member. The coupling member is configured such that the coupling state with the guide member can be canceled when the inverter is pressed from the front side toward the rear side.

### CITATION LIST

### Patent Literature

### PTL 1: Japanese Patent Laying-Open No. 2008-248936

### PTL 2: Japanese Patent Laying-Open No. 2009-90818

### SUMMARY OF INVENTION

### Technical Problem

However, in the enclosure-fixing structure described in Japanese Patent Laying-Open No. 2008-248936, when a load heavier than specified is applied to the enclosure, the enclosure cannot be separated from the vehicular body. An excessive load may thus be applied to the enclosure, damaging the enclosure and the inverter stored in the enclosure.

In the fixing structure for on-board equipment described in Japanese Patent Laying-Open No. 2009-90818, a buffer member is not provided between the inverter and the coupling member, so that driving vibrations of the inverter may be transmitted to the coupling member and the vehicular body and/or vibrations of the vehicular body side may be transmitted to the inverter.

The present invention was made in view of the above-described problems, and has an object to provide a case-fixing structure capable of preventing vibrations from being transmitted between the outside and the case and capable of canceling fixation of the case when a load heavier than specified is applied to the case.

### Solution to Problem

A case-fixing structure according to the present invention includes a seat plate, a case located on the seat plate, a connecting member connected to the seat plate, a coupling member fixed to the connecting member and coupling the connecting member and the case, a buffer member disposed between the coupling member and the case, and a contact part provided for the case. When a load heavier than specified is applied to the case, the contact part can be brought into contact with at least one of the coupling member, the connecting member and the seat plate, and when the contact part is brought into contact with at least one of the coupling member, the connecting member and the seat plate, connection between the connecting member and the seat plate can be canceled.

Preferably, the buffer member is bonded to the case and the connecting member and is elastically deformable, and when a load heavier than specified is applied to the case, the buffer member deforms to be brought into contact with at least one of the coupling member, the connecting member and the seat plate.

Preferably, the coupling member is fixed to the connecting member, and the coupling member includes an engagement part located at a spacing from the connecting member. The contact part is located between the connecting member and the engagement part and disposed at a spacing from the engagement part. When a load heavier than specified is applied to the case, the contact part and the engagement part can be brought into contact with each other.

Preferably, the coupling member includes a defining member located between the engagement part and the connecting member and defining a spacing between the engagement part and the connecting member.

Preferably, the coupling member is fixed to the connecting member, and the coupling member includes an engagement part located at a spacing from the connecting member. The contact part is located between the connecting member and the engagement part and disposed at a spacing from the connecting member, and when a load heavier than specified is applied to the case, the contact part and the connecting member can be brought into contact with each other.

Preferably, the case is mounted on a vehicle, and a circumferential surface of the case includes a front surface and a rear surface. The coupling member and the connecting member are provided on at least one of the front surface and the rear surface. Preferably, an inverter is stored in the case.

### Advantageous Effects of Invention

With the case-fixing structure according to the present invention, a case-fixing structure capable of preventing vibrations from being transmitted between the case and the outside and capable of preventing an excessive load from being applied to the case is proposed.

### BRIEF DESCRIPTION OF DRAWINGS

FIG. 1 is a schematic view showing a general structure of a hybrid vehicle 1 according to an embodiment of the present invention.

FIG. 2 is a circuit diagram of PCU.

FIG. 3 is a plan view schematically showing a case-fixing structure storing inverters 12, 13.

FIG. 4 is a side view schematically showing the case-fixing structure shown in FIG. 3.

FIG. 5 is a cross sectional view showing a projecting part 27 and a structure located therearound.

FIG. 6 is a perspective view of a connecting member 23.

FIG. 7 is a cross sectional view showing a coupling member 24.

FIG. 8 is a cross sectional view showing coupling member 24 when impact force is externally applied to a case 21.

FIG. 9 is a cross sectional view showing a coupling member 30 and a structure located therearound.

FIG. 10 is a perspective view of a connecting member 29.

FIG. 11 is a cross sectional view showing coupling member 30 when a load heavier than specified is applied to case 21.

FIG. 12 is a cross sectional view showing a variation of coupling member 30.

### DESCRIPTION OF EMBODIMENTS

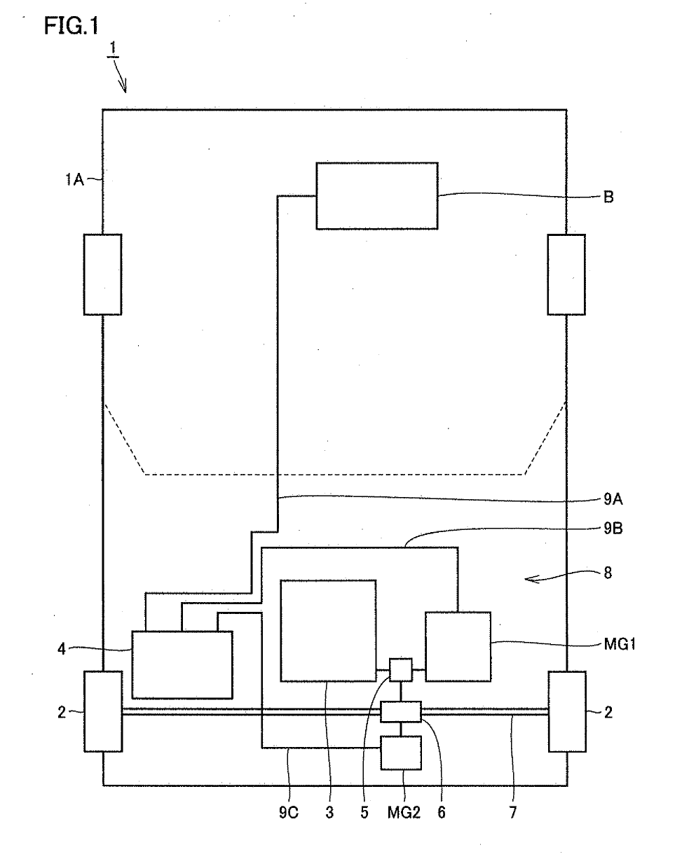

A fixing structure for on-board equipment according to the present embodiment will be described with reference to FIGS. 1 to 9.

When the number, an amount or the like is mentioned in the embodiment described below, the scope of the present invention is not necessarily limited to that number, that amount or the like, unless otherwise specified. In addition, in the embodiment below, each component is not necessarily essential in the present invention, unless otherwise specified. Moreover, when a plurality of examples are shown below, combination as appropriate of features in the respective examples is originally encompassed, unless otherwise specified.

FIG. 1 is a schematic view showing a general structure of hybrid vehicle 1 according to an embodiment of the present invention. As shown in this FIG. 1, hybrid vehicle 1 includes a vehicular body 1A, wheels 2 provided for this vehicular body 1A, an engine 3 mounted on vehicular body 1A, a PCU (Power Control Unit) 4, a power split device 5, a differential 6, and a battery B.

Vehicular body 1A is provided with an engine compartment 8, and engine 3, PCU 4 and motor generators MG1, MG2 are disposed in this engine compartment 8.

Engine 3 and motor generator MG1 are connected to power split device 5. Power split device 5 is connected to differential 6, and differential 6 is connected to a drive shaft 7.

Motor generator MG1 and PCU 4 are connected via a cable 9B, and motor generator MG2 and PCU 4 are connected via a cable 9C. PCU 4 and battery B are connected via a cable 9A.

Power split device 5 transmits motive power produced by engine 3 to differential 6 or to motor generator MG1.

Motor generator MG1 operates as a power generator driven by engine 3. Motor generator MG1 is configured to have functions of a motor and a power generator as operating as a motor that starts engine 3.

The output of motor generator MG2 is transmitted to drive shaft 7 via differential 6.

The output of motor generator MG2 is transmitted to wheels 2 via deferential 6 and drive shaft 7. That is, motor generator MG2 is mounted on hybrid vehicle 1 as a drive motor. Furthermore, motor generator MG2 performs regenerative power generation by producing output torque in a direction opposite to the direction of rotation of wheels 2, and functions as a motor and a power generator.

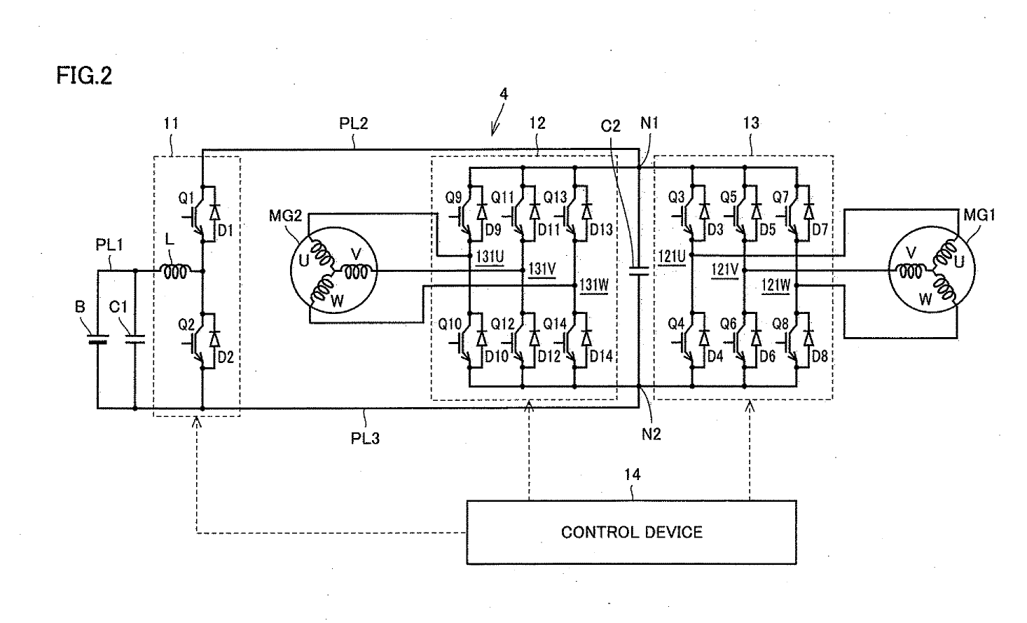

FIG. 2 is a circuit diagram of PCU. Referring to FIG. 2, PCU 4 includes a converter 11, inverter 12, inverter 13, a capacitor C1, and a capacitor C2.

Converter 11 is connected between battery B and inverters 12, 13. Inverter 12 is connected to motor generator MG2, and inverter 13 is connected to motor generator MG1.

Converter 11 includes power transistors Q1, Q2, diodes D1, D2, and a reactor L. Power transistors Q1, Q2 are connected in series and receive at their bases a control signal from a control device 14. Diodes D1, D2 are connected between the collector and the emitter of power transistors Q1, Q2, respectively, such that electric current flows from the emitter side to the collector side of power transistors Q1, Q2, respectively. Reactor L has one end connected to a power source line PL1 connected to a positive electrode of battery B, and the other end connected to a connection point between power transistors Q1 and Q2.

This converter 11 boosts a DC voltage received from battery B using reactor L, and supplies that boosted voltage to a power source line PL2. Converter 11 also steps down a DC voltage received from inverters 12, 13 for charging battery B.

Inverters 12, 13 include U-phase arms 121U, 131U, V-phase arms 121V, 131V, and W-phase arms 121W, 131W, respectively. U-phase arm 121U, V-phase arm 121V and W-phase arm 121W are connected in parallel between nodes N1 and N2. Similarly, U-phase arm 131U, V-phase arm 131V and W-phase arm 131W are connected in parallel between nodes N1 and N2.

U-phase arm 121U includes two power transistors Q3, Q4 connected in series. Similarly, U-phase arm 131U, V-phase arms 121V, 131V and W-phase arms 121W, 131W include two of power transistors Q5 to Q14 connected in series, respectively. In addition, connected between the collector and the emitter of respective power transistors Q3 to Q14 are diodes D3 to D14 flowing electric current from the emitter side to the collector side, respectively.

An intermediate point of the arm of each phase of inverters 12, 13 is connected to an end of each phase of a coil of each phase of motor generators MG1, MG2, respectively. Motor generators MG1, MG2 are configured such that one ends of three coils of U, V and W-phases are connected in common to the middle point.

Capacitor C1 is connected across power source lines PL1 and PL3 to smooth the voltage level of power source line PL1. Capacitor C2 is connected across power source lines PL2 and PL3 to smooth the voltage level of power source line PL2.

Inverters 12, 13 convert a DC voltage from capacitor C2 to an AC voltage based on a driving signal from control device 14 to drive motor generators MG1, MG2.

Control device 14 calculates a voltage of a coil of each phase of motor generators MG1, MG2 based on a motor torque command value, a current value of each phase of motor generators MG1, MG2, and input voltages of inverters 12, 13, and based on the calculation result, generates a PWM (Pulse Width Modulation) signal for turning on/off power transistors Q3 to Q14 and outputs the signal to inverters 12, 13.

Control device 14 also calculates a duty ratio of power transistors Q1, Q2 for optimizing the input voltages of inverters 12, 13 based on the above-mentioned motor torque command value and a motor speed, and based on the calculation result, generates a PWM signal for turning on/off power transistors Q1, Q2 and outputs the signal to converter 11.

Furthermore, control device 14 controls the switching operation of power transistors Q1 to Q14 in converter 11 and inverters 12 and 13 in order to convert AC power generated by motor generators MG1, MG2 to DC power for charging battery B.

Inverters 12 and 13 are stored in a single case, for example. Converter 11, capacitors C1, C2, and the like may also be stored in this case.

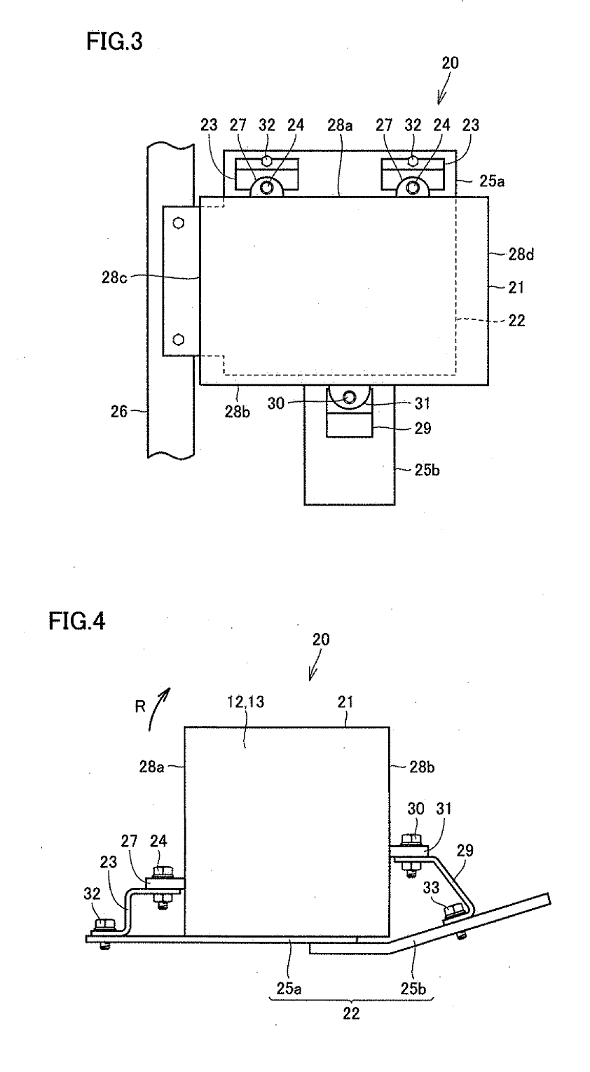

FIG. 3 is a plan view schematically showing a case-fixing structure storing inverters 12 and 13, and FIG. 4 is a side view schematically showing the case-fixing structure shown in FIG. 3.

As shown in FIG. 3, a case-fixing structure 20 includes case 21 storing electric instrument including inverters 12, 13, for example, a seat plate 22 on which case 21 is mounted, connecting member 23 connected to seat plate 22, and coupling member 24 fixed to connecting member 23 and coupling connecting member 23 and case 21. Seat plate 22 includes a support plate 25a on which case 21 is mounted and an inclined plate 25b provided on a rear side part of this support plate 25a.

Support plate 25a is fixed to a side member 26. Side member 26 is a part that forms the frame of vehicular body 1A. Inclined plate 25b is inclined upward from the rear side part of support plate 25a toward the rear side of the vehicle.

Case-fixing structure 20 includes connecting member 29 connected to inclined plate 25b and coupling member 30 coupling connecting member 29 and case 21.

Although case 21 is mounted on the upper surface of support plate 25a in this example shown in FIG. 4, the bottom surface of case 21 may be spaced from the upper surface of support plate 25a.

The circumferential surface of case 21 includes a front surface 28a located on the front side of the vehicle, a rear surface 28b located on the opposite side of front surface 28a, and side surfaces 28c and 28d arranged in the widthwise direction of the vehicle.

Front surface 28a is provided with projecting part 27 formed to protrude from front surface 28a, and a plurality of projecting parts 27 are formed at spacings in the widthwise direction of the vehicle. Connecting member 23 connects projecting part 27 and support plate 25a, and coupling member 24 couples projecting part 27 and connecting member 23. Rear surface 28b is also provided with projecting part 31 projecting from rear surface 28b. Coupling member 30 couples projecting part 31 and connecting member 29.

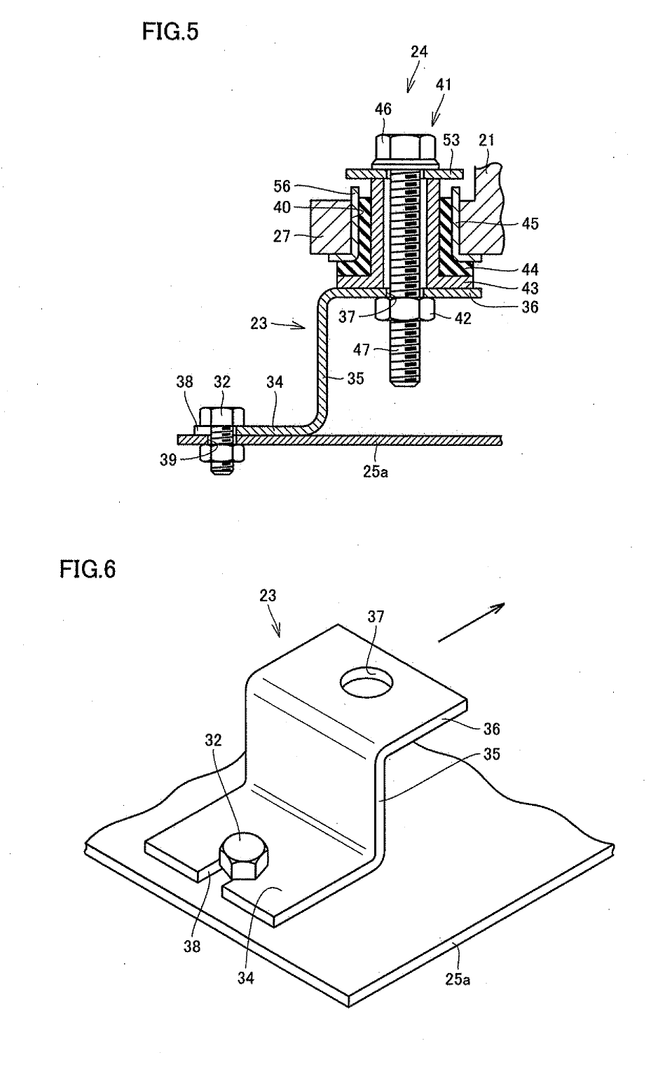

FIG. 5 is a cross sectional view showing projecting part 27 and a structure located therearound. As shown in this FIG. 5, connecting member 23 includes a piece part 34 disposed on support plate 25a, a piece part 35 formed to stand from an end of piece part 34, and a piece part 36 provided in communication with an end of piece part 35 and extending horizontally. A hole 37 is formed in piece part 36, and a slit part 38 is formed in piece part 34. A hole 39 is formed in support plate 25a.

A fastening member 32 typically includes a bolt and a nut. The bolt includes a shank with a screw part formed on its circumferential surface and a head part formed on an end of the shank. The shank of the bolt is inserted through slit part 38 and hole 39, and the head part of the bolt and the nut sandwich and secure support plate 25a and piece part 34.

FIG. 6 is a perspective view of connecting member 23. As shown in this FIG. 6 and FIG. 5, slit part 38 is formed to extend from the front side part of piece part 34 toward the rear side of the vehicle. Therefore, connecting member 23 is configured to be movable toward the rear side of the vehicle when pressed toward the rear side of the vehicle with a load heavier than specified, and the connection state between connecting member 23 and support plate 25a can be canceled.

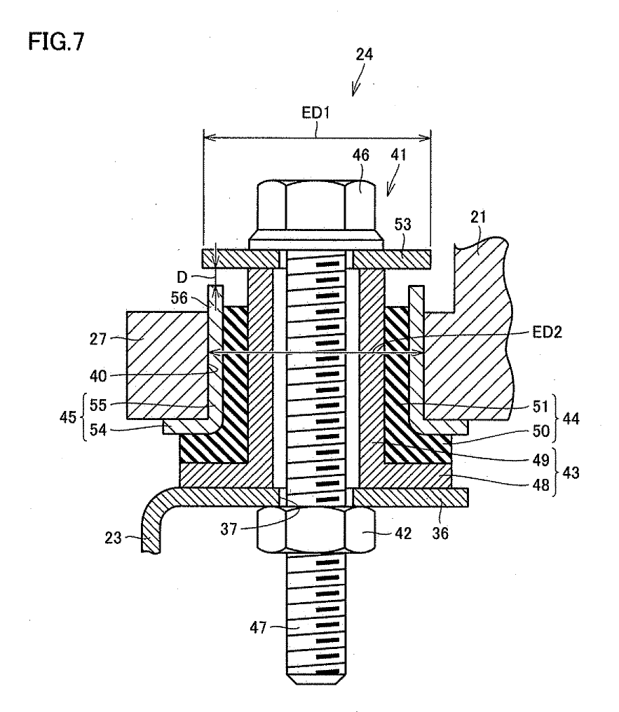

FIG. 7 is a cross sectional view showing coupling member 24. As shown in this FIG. 7, a hole 40 is formed in projecting part 27. Coupling member 24 includes a bolt 41 inserted through holes 40 and 37, a nut 42 threadedly engaged with bolt 41, an inner tube part 43 disposed on the upper surface of piece part 36, a buffer member 44 disposed on the upper surface of this inner tube part 43, and a washer (engagement part) 53. An outer tube part 45 is fixed to the inner circumferential surface of hole 40.

Bolt 41 includes a shank 47 with a screw part formed on its circumferential surface and a head part 46 formed on the upper end of shank 47. Bolt 41 is threadedly engaged with nut 42 disposed on the lower surface of piece part 36.

Inner tube part (defining member) 43 is disposed on the upper surface of piece part 36, and is disposed around shank 47. Inner tube part 43 includes a bottom plate part 48 in which a hole is formed and a tube part 49 defining a hole communicating with this hole. The upper end of tube part 49 abuts on head part 46 with washer 53 interposed therebetween. Therefore, the distance between head part 46 and nut 42 is defined by the height of inner tube part 43.

Because nut 42 and the screw part formed in shank 47 are threadedly engaged, nut 42 and head part 46 sandwich washer 53, inner tube part 43 and piece part 36, and bolt 41, washer 53 and inner tube part 43 are integrally fixed to piece part 36. Buffer member 44 is bonded to inner tube part 43, and coupling member 24 including bolt 41, nut 42, inner tube part 43, buffer member 44, and washer 53 is fixed to piece part 36.

Buffer member 44 includes a bottom 50 located on the upper surface of bottom plate part 48 and a tube part 51 disposed on the circumferential surface of tube part 49.

Outer tube part 45 includes a tube part 55 attached to the inner circumferential surface of hole 40 and a bottom 54 formed on the lower end of tube part 55. It is noted that tube part 55 has an outer diameter ED2 smaller than an outer diameter ED1 of washer 53.

Buffer member 44 is formed between inner tube part 43 and outer tube part 45. Specifically, bottom 50 of buffer member 44 is located between bottom plate part 48 of inner tube part 43 and bottom 54 of outer tube part 45, and bonds bottom plate part 48 and bottom 54. Tube part 51 is located between tube part 55 and tube part 49, and bonds tube part 55 and tube part 49.

Here, when the inverter stored in case 21 is driven, vibrations are transmitted to case 21 and outer tube part 45. Since buffer member 44 is disposed between outer tube part 45 and inner tube part 43, vibrations are prevented from being transmitted from outer tube part 45 to inner tube part 43. Since vibrations are prevented from being transmitted to inner tube part 43, driving vibrations are prevented from being transmitted to the vehicular body side.

A protruding part (contact part) 56 protruding from the upper surface of projecting part 27 is formed on the upper end of tube part 55. Buffer member 44 is composed of an elastically deformable resin, for example. In the normal state where external force is not applied to case 21, a clearance is formed between protruding part 56 and washer 53. Therefore, driving vibrations are prevented from traveling from outer tube part 45 and through washer 53 to reach connecting member 23.

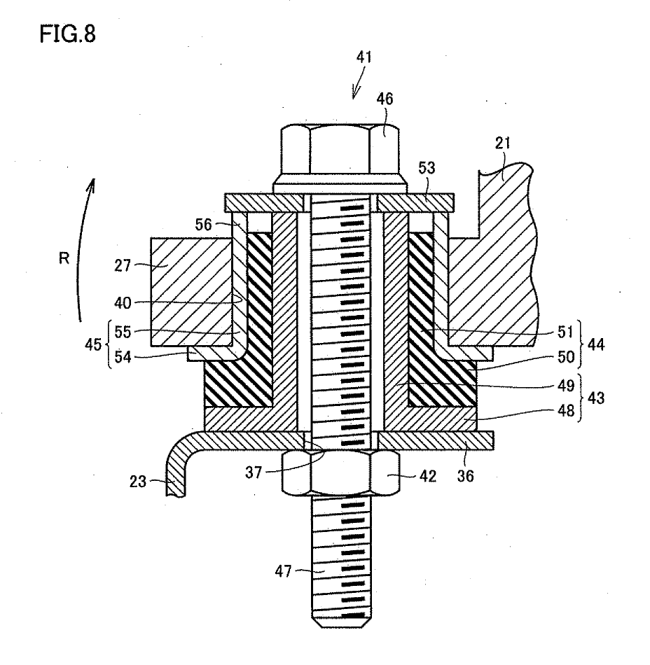

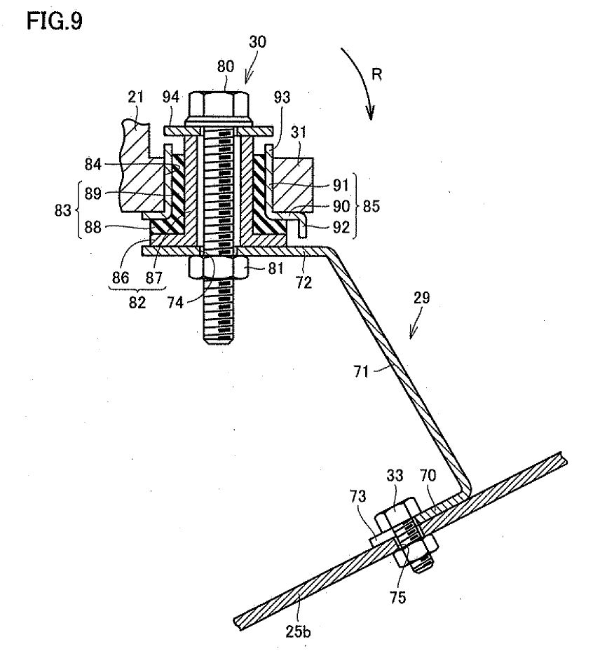

FIG. 8 is a cross sectional view showing coupling member 24 when impact force is externally applied to case 21. A moving direction R in FIG. 8 shows an example of moving direction of case 21 when a load heavier than specified is applied to case 21.

When a load is applied to case 21, buffer member 44 elastically deforms, and case 21 is displaced upward from the state shown in FIG. 7. Since outer tube part 45 is fixed to projecting part 27, outer tube part 45 moves upward together with case 21. Outer diameter ED1 of washer 53 is formed to be larger than outer diameter ED2 of tube part 55, and when the load applied to case 21 is heavier than a predetermined load, protruding part 56 hits washer 53.

When protruding part 56 abuts on washer 53, the load applied to case 21 is transmitted to connecting member 23 via washer 53, bolt 41 and nut 42. When the load is applied to connecting member 23, the connection state between support plate 25a and connecting member 23 shown in FIG. 5 is canceled.

Here, in FIG. 7, representing the distance between protruding part 56 in the normal state and washer 53 by a distance D and the spring modulus of buffer member 44 by “K”, the relationship between “D” and “K” satisfies an expression (1) below. It is noted that, in expression (1) below, “F1” indicates a load acting on one buffer member 44 and a load when connecting member 23 falls down from support plate 25a.

D<F1/K (1)

In addition, representing a load acting on one buffer member 44 by inertia forces of case 21 and inverters 12, 13 stored in case 21 as a result of vibrations while the vehicle is running (e.g., about 5G) by “F2”, “F2”, “D” and “K” satisfy an expression (2) below.

D>F2/K (2)

In FIG. 4, when connection between connecting member 23 and support plate 25a is canceled, case 21 is brought into a movable state and can release the load applied to case 21. This can prevent an excessive load from being applied to case 21. This can prevent electric instrument such as the inverters stored in case 21 from being damaged.

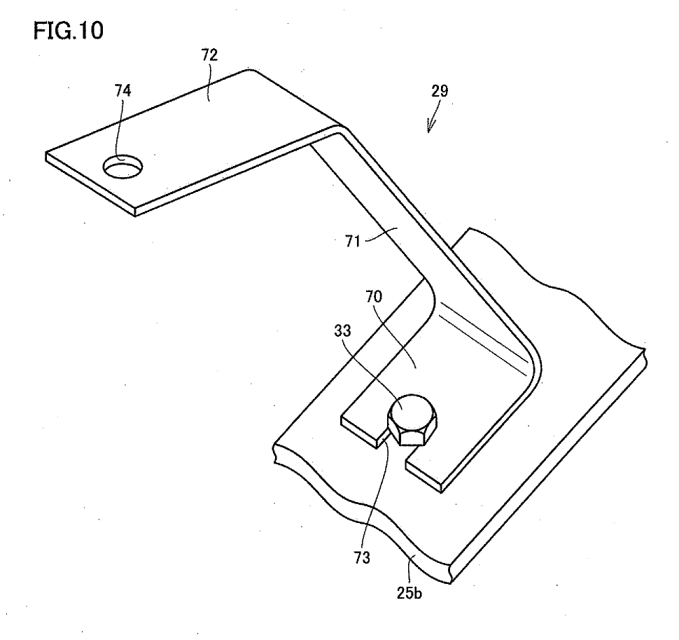

FIG. 9 is a cross sectional view showing coupling member 30 and a structure located therearound. As shown in this FIG. 9, coupling member 30 couples connecting member 29 and projecting part 31. Connecting member 29 is removably fixed to inclined plate 25b. FIG. 10 is a perspective view of connecting member 29.

In this FIG. 10 and FIG. 9, connecting member 29 includes a piece part 70 disposed on the upper surface of inclined plate 25b, a piece part 71 connected to this piece part 70 and extending upward, and a piece part 72 connected to the upper end of piece part 71 and extending horizontally.

A slit part 73 is formed in piece part 70, and a hole 74 is formed in piece part 72. Slit part 73 extends rearward from the front side part of piece part 70. A fastening member 33 typically includes a bolt and a nut. The shank of the bolt is inserted through a hole 75 formed in inclined plate 25b and slit part 73, and the shank of the bolt is threadedly engaged with the nut. The head part of the bolt and the nut sandwich piece part 70 and inclined plate 25b, so that piece part 70 and inclined plate 25b are secured.

When a load directed to the rear side of the vehicle is applied to connecting member 29, the connection state between connecting member 29 and inclined plate 25b is canceled.

In FIG. 9, coupling member 30 includes a bolt 80, a nut 81 disposed on the lower surface of piece part 72 and threadedly engaged with bolt 80, an inner tube part 82 disposed on the upper surface of piece part 72, and a buffer member 83 disposed on the upper surface of this inner tube part 82.

Inner tube part 82 includes a bottom 86 disposed on the upper surface of piece part 72 and having a hole formed therein, and a tube part 87 defining a hole communicating with this hole. Buffer member 83 also includes a bottom 88 and a tubular tube part 89. A hole 84 is formed in projecting part 31, and an outer tube part 85 is fixed to this hole 84. Outer tube part 85 includes a bottom 90 in which a hole is formed, a tube part 91 defining a hole communicating with this hole, and a contact part 92 formed on the outer circumferential edge of bottom 90. A protruding part 93 protruding from the upper surface of projecting part 31 is formed on the upper end of tube part 91. Contact part 92 is formed to extend downward from the outer circumferential edge of bottom 90.

Elastically deformable buffer member 83 is disposed between outer tube part 85 and inner tube part 82. This can prevent driving vibrations of the inverters, for example, from being transmitted from outer tube part 85 to inner tube part 82 and connecting member 29.

The state shown in this FIG. 9 indicates the normal state where external force is not applied to case 21. In the normal state, contact part 92 is spaced from the upper surface of piece part 72. Therefore, driving vibrations of the inverters, for example, are prevented from being transmitted from outer tube part 85 to connecting member 29.

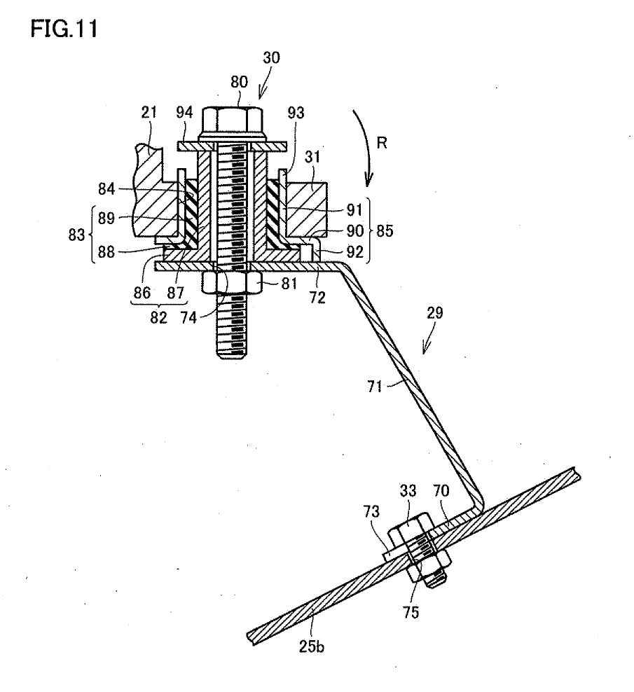

FIG. 11 is a cross sectional view showing coupling member 30 when a load heavier than specified is applied to case 21. As shown in this FIG. 11, case 21 is going to be displaced in moving direction R.

On this occasion, when the load applied to case 21 increases, buffer member 83 elastically deforms, and contact part 92 comes into contact with piece part 72. Accordingly, a load is applied to connecting member 29, and connecting member 29 is displaced over inclined plate 25b toward the rear side of the vehicle. As a result, the connection state between inclined plate 25b and connecting member 29 is canceled.

In this way, when the connection state between connecting member 29 and inclined plate 25b is canceled, case 21 is brought into a movable state. Case 21 is thereby moved, and can thus release the load applied to case 21.

In FIG. 4, when the connection state between connecting member 23 and support plate 25a is canceled while the connection state between connecting member 29 and inclined plate 25b is canceled, case 21 is no longer connected to the vehicular body.

Therefore, case 21 is displaced by the load applied to case 21. For example, when case 21 is pressed toward the rear side of the vehicle, case 21 rides on inclined plate 25b and is guided by inclined plate 25b. Inclined plate 25b guides case 21 upward and prevents case 21 from colliding with on-board equipment, for example, disposed around case 21.

It is noted that, in the above-described example shown in FIG. 9, protruding part 93 is formed on the upper end of tube part 91. Therefore, when a load is applied to case 21 and case 21 is moved in a direction opposite to moving direction R, protruding part 93 abuts on a washer 94. Then, the load applied to case 21 is transmitted to bolt 80 and connecting member 29. The connection state between connecting member 29 and inclined plate 25b is thereby canceled. It is noted that contact part 92 shown in FIG. 9 may be also formed on bottom 54 shown in FIG. 7.

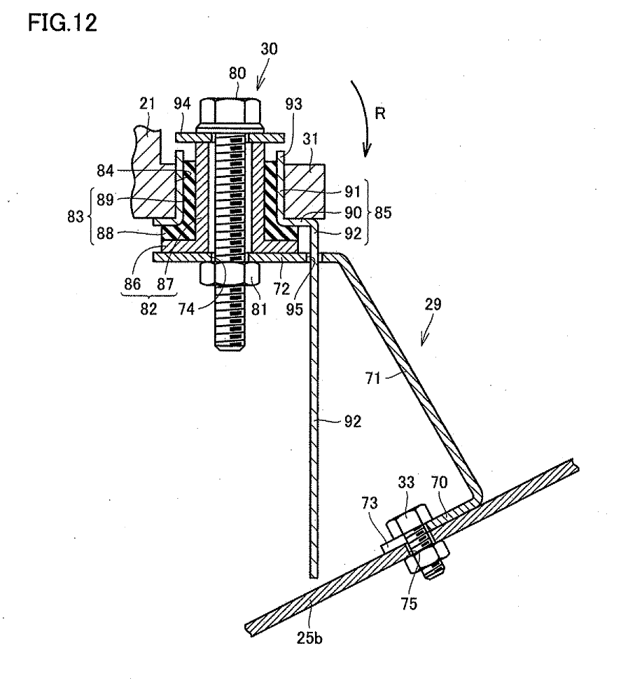

FIG. 12 is a cross sectional view showing a variation of coupling member 30. In the example shown in this FIG. 12, contact part 92 extends through a hole 95 formed in piece part 72 to reach the vicinity of the upper surface of inclined plate 25b. In the normal state, a clearance is formed between the leading end of contact part 92 and the upper surface of inclined plate 25b.

When a load heavier than specified is applied to case 21 and case 21 is moved in moving direction R, then the lower end of contact part 92 and inclined plate 25b come into contact. When contact part 92 and inclined plate 25b come into contact, case 21 is moved with the abutting position between contact part 92 and inclined plate 25b serving as a fulcrum. As a result, coupling member 30 and connecting member 29 are also moved with case 21, and the connection state between connecting member 29 and inclined plate 25b is canceled.

Case-fixing structure 20 according to the present embodiment is provided such that outer tube part 45 fixed to projecting part 27 comes into contact with at least one of washer 53 of coupling member 24 and connecting member 23, or outer tube part 85 fixed to projecting part 31 comes into contact with any one of washer 94 of coupling member 30, connecting member 29 and inclined plate 25b. Therefore, when a load heavier than specified is applied to case 21, the fixation state of case 21 can be canceled, which can prevent case 21 from being damaged severely.

It is noted that, in case-fixing structure 20 according to the present embodiment, the protruding part and the contact part of the outer tube part provided for case 21 abut on the coupling member and the like, however, sections to be in contact with the coupling member and the like may be formed at other positions. Specifically, the protruding part and the contact part may be formed directly in case 21.

While the embodiment of the present invention has been described as above, it should be understood that the embodiment disclosed herein is illustrative and non-restrictive in every respect. The scope of the present invention is defined by the terms of the claims, and is intended to include any modifications within the meaning and scope equivalent to the terms of the claims. Furthermore, the above-described numeric values and the like are illustrative, and the above-described numeric values and ranges are not limitations.

### INDUSTRIAL APPLICABILITY

The present invention is applicable to a case-fixing structure and is particularly suitable for a case-fixing structure including a case and a seat plate on which the case is mounted.

### REFERENCE SIGNS LIST

1 hybrid vehicle; 1A vehicular body; 2 wheel; 3 engine; 4 PCU; 5 power split device; 6 deferential; 7 drive shaft; 8 engine compartment; 9A, 9B, 9C cable; 11 converter; 12, 13 inverter; 14 control device; 20 fixing structure; 21 case; 22 seat plate; 23, 29 connecting member; 24, 30 coupling member; 25a support plate; 25b inclined plate; 26 side member; 27, 31 projecting part; 28a front surface; 28b rear surface; 32, 33 fastening member; 34, 35, 36 piece part; 38 slit part; 41, 80 bolt; 42, 81 nut; 43, 82 inner tube part; 44, 83 buffer member; 45, 85 outer tube part; 46 head part; 47 shank; 53, 94 washer; 56, 93 protruding part; 73 slit part; 84 hole; 92 contact part; D distance; ED1 outer diameter; ED2 outer diameter; L reactor; MG1, MG2 motor generator; R moving direction.

1. A case-fixing structure comprising:
a seat plate;
a case located on said seat plate;
a connecting member connected to said seat plate;
a coupling member fixed to said connecting member and coupling said connecting member and said case;
a buffer member disposed between said coupling member and said case; and
a contact part provided for said case, wherein
when a load heavier than specified is applied to said case, said contact part can be brought into contact with at least one of said coupling member, said connecting member and said seat plate, and
when said contact part is brought into contact with at least one of said coupling member, said connecting member and said seat plate, connection between said connecting member and said seat plate can be canceled.

2. The case-fixing structure according to claim 1, wherein
said buffer member is bonded to said case and said connecting member and is elastically deformable, and
when a load heavier than specified is applied to said case, said buffer member deforms to be brought into contact with at least one of said coupling member, said connecting member and said seat plate.

3. The case-fixing structure according to claim 1, wherein
said coupling member is fixed to said connecting member,
said coupling member includes an engagement part located at a spacing from said connecting member, and
said contact part is located between said connecting member and said engagement part and disposed at a spacing from said engagement part, and when a load heavier than specified is applied to said case, said contact part and said engagement part can be brought into contact with each other.

4. The case-fixing structure according to claim 3, wherein said coupling member includes a defining member located between said engagement part and said connecting member and defining a spacing between said engagement part and said connecting member.

5. The case-fixing structure according to claim 1, wherein
said coupling member is fixed to said connecting member,
said coupling member includes an engagement part located at a spacing from said connecting member, and
said contact part is located between said connecting member and said engagement part and disposed at a spacing from said connecting member, and when a load heavier than specified is applied to said case, said contact part and said connecting member can be brought into contact with each other.

6. The case-fixing structure according to claim 1, wherein
said case is mounted on a vehicle,
a circumferential surface of said case includes a front surface and a rear surface, and
said coupling member and said connecting member are provided on at least one of said front surface and said rear surface.

7. The case-fixing structure according to claim 1, wherein an inverter is stored in said case.

8. The case-fixing structure according to claim 1, wherein
said case includes a projecting part formed to protrude from a circumferential surface,
a first hole is formed in said projecting part,
a second hole is formed in said connecting member,
said contact part is formed in a portion of an outer tube part fixed to an inner circumferential surface of said first hole, the portion protruding from said projecting part,
said coupling member includes a fastener having a shank inserted through said first hole and said second hole, an inner tube part through which said shank is inserted, and an engagement part,
said engagement part is disposed on an end of said inner tube part,
said engagement part, said inner tube part and said connecting member are integrally secured by said fastener,
said buffer member is disposed between said outer tube part and said inner tube part and is formed to be bonded to an inner circumferential surface of said outer tube part and an outer circumferential surface of said inner tube part,
a clearance is formed between said engagement part and said contact part, and
when a load heavier than specified is applied to said case, said contact part is brought into contact with said engagement part.
